(19) United States
(12) Patent Application Publication
(10) Pub. No.: US 2021/0005937 A1
(43) Pub. Date: Jan. 7, 2021

(54) ELECTROLYTES FOR RECHARGEABLE Zn-METAL BATTERY

(71) Applicant: University of Maryland, College Park, College Park, MD (US)

(72) Inventors: Chunsheng Wang, Silver Spring, MD (US); Fei Wang, College Park, MD (US)

(73) Assignee: University of Maryland, College Park, College Park, MD (US)

(21) Appl. No.: 16/982,537

(22) PCT Filed: Mar. 20, 2019
(86) PCT No.: PCT/US2019/023170

§ 371 Date: Sep. 18, 2020

Related U.S. Application Data
(60) Provisional application No. 62/645,669, filed on Mar. 20, 2018.

(51) Int. Cl. H01M 10/36; H01M 10/0569

(52) U.S. Cl. CPC H01M 10/36; H01M 2300/0034; H01M 10/0569

(57) ABSTRACT

The present invention provides an electrolyte for a rechargeable zinc-metal battery. The electrolyte comprises an aqueous solution having a pH of from about 3 to about 7; a zinc-ion based electrolyte comprising zinc ion and a fluorine containing anion; and a lithium salt of said fluorine containing anion. The electrolyte of the present invention not only enables substantially dendrite-free Zn plating/stripping at nearly 100% CE, but also retains water in the open atmosphere.

### CROSS-REFERENCE TO RELATED APPLICATIONS

This application claims the priority benefit of U.S. Provisional Application No. 62/645,669 filed Mar. 20, 2018, which is incorporated herein by reference in its entirety.

### STATEMENT REGARDING FEDERALLY FUNDED RESEARCH

This invention was made with government support under DEAR0000389 awarded by DOE ARPA-E. The government has certain rights in the invention.

### FIELD OF THE INVENTION

The present invention relates to an electrolyte for a rechargeable zinc-metal battery. The electrolyte comprises an aqueous solution having a pH of from about 3 to about 7; a zinc-ion based electrolyte comprising zinc ion and a first fluorine containing anion; and a secondary salt comprising a cation (e.g., lithium or alkaline, alkaline-earth or a transition metal ion) and a second fluorine containing anion. In some embodiments, the first and the second fluorine containing anions are the same. In other embodiments, the first and the second fluorine containing anions are different.

### BACKGROUND OF THE INVENTION

Since its appearance in the very first battery, metallic zinc (Zn) has been regarded as an ideal anode material for aqueous batteries, because of its high theoretical capacity (820 mAh/g), low electrochemical potential (−0.762 V vs. SHE), high abundance, low toxicity, along with intrinsic safety from their aqueous nature. These advantages directly drove the recent renaissance of rechargeable Zn battery development. However, the Zn anode in alkaline electrolytes persistently suffers from severe irreversibility issues, caused by low coulombic efficiency (CE) of its plating/striping, dendrite growth during cycling, sustained water consumption and irreversible by-products, such as Zn hydroxides or zincates. Although Zn dendrite formation could be minimized in neutral (pH=7) electrolytes, its low plating/striping CE remains a severe challenge. In most previous reports, high charge/discharge rates had to be used to reduce the effect of poor reversibility on cycling life, and regularly replenishing the electrolyte with water was often required to compensate the water decomposition. Zn also had to be used in significant excess to maintain the supply during its consumption by side-reactions, leading to substantial under-utilization of its theoretical capacity.

The expansion in the electrochemical stability window of aqueous electrolytes and other advantages brought about by the recent discovery of water-in-salt electrolytes provide an unprecedented opportunity to resolve the irreversibility issue of Zn anode in aqueous electrolytes. Without being bound by any theory, it is believed that this irreversibility of Zn anode is closely associated with solvation sheath structure of the divalent zinc cation. In particular, it is believed that the strong interaction between Zn²⁺ and water molecules constitutes high energy barrier for a solvated Zn²⁺ to desolvate and deposit, while the generation of hydroxyl ion (OH⁻) via water decomposition often drives the formation of Zn(OH)₂, which further converts to insoluble ZnO and becomes electrochemically inactive. It is also believed that strongly-bound zincate complexes further promote dendrite formation. These problems associated with conventional electrolytes, typically in alkaline solutions, severely limit the number of recharging and coulombic efficiency of conventional rechargeable Zn-metal batteries.

Therefore, there is a need for an electrolyte for rechargeable Zn-metal batteries that can overcome some, if not many, of these problems.

### SUMMARY OF THE INVENTION

Surprisingly and unexpectedly, the present inventors have discovered that a very effective solution to at least some of the problems associated with conventional electrolyte is to use a zinc-ion based electrolyte that includes zinc ion and a first fluorine containing anion (i.e., as a counter-ion of zinc ion); and a secondary salt. The secondary salt comprises a salt (e.g., a lithium salt or other alkaline, alkaline-earth, or transition metal salt) of a second fluorine containing anion, i.e., it comprises a cation and a second fluorine containing anion. In some embodiments, the first and the second fluorine containing anions are the same. In other embodiments, the first and the second fluorine containing anions are different. It should be appreciated that the secondary salt is different from the zinc-ion based electrolyte. Thus, if the first and the second fluorine containing anion is the same, then the secondary salt cannot be a zinc based metal salt. On the other hand, if the first and the secondary fluorine containing anion is different, then the secondary salt can be a zinc based metal salt. The electrolyte of the present invention not only enables substantially dendrite-free Zn plating/stripping at nearly 100% CE, but also retains water in the open atmosphere, making hermetic cell configurations optional. These merits bring unprecedented flexibility and reversibility to Zn batteries.

One aspect of the invention provides an electrolyte for a rechargeable zinc-metal battery comprising:
an aqueous solution having a pH of from about 3 to about 7;
a zinc-ion based electrolyte comprising zinc ion and a first fluorine containing anion; and
a secondary salt comprising a cation (e.g., alkaline metal ion such as lithium, alkaline-earth metal ion, a transition metal ion, a quaternary amine, or other cations including those that can form an ionic liquid with a second fluorine containing anion) and a second fluorine containing anion.

In some embodiments, the first and the second fluorine containing anions are the same. In other embodiments, the first and the second fluorine containing anions are different.

In one embodiment, the fluorine containing anion suppresses hydrolysis of the zinc-ion based electrolyte. In this manner, the amount of zincate formed is significantly reduced. In some instances, the amount of zincate formed is reduced by at least about 50%, typically at least about 80%, often at least about 90%, and more often at least about 95% compared to a conventional electrolyte solution. Conventional electrolytes for Zn-metal are typically summarized as the following two kinds: First is a dilute Zn-ion solution. For example, the ZnSO₄ solutions from 1M to 3M in water and the pH value of about 4. Second is alkaline solutions, for example, KOH solutions from 1M to saturated in water and the pH value of about 14.

Yet in another embodiment, the presence of fluorine containing anion and the lithium salt of the fluorine containing anion inhibits formation of zinc oxide, zinc hydroxide, or both. In some instances, the amount of zinc oxide formed is reduced by at least about 80%, typically at least about 80%, often at least about 90%, and more often at least about 95% compared to a conventional electrolyte solution.

Still in another embodiment, the electrolyte of the invention is capable of retaining water in open atmosphere.

In other embodiments, the zinc-ion based electrolyte provides dendrite-free plating/stripping of Zn anode at a coulombic efficiency of at least about 90%, typically at least about 95%, often at least 98%, and more often at least about 99%.

Yet still in other embodiments, the ratio of the secondary salt (e.g., lithium salt) of the second fluorine containing anion to the zinc-ion based electrolyte is at least about 10 to 1, typically at least about 15:1, and often at least about 20:1.

Still in other embodiments, the fluorine containing anion comprises a fluoroalkylsulfonyl group of the formula: R—SO₂—, wherein R is a fluoroalkyl group of 1 to 20 carbons. In some instances, R is a C₁₋₂₀ perfluoroalkyl.

In other embodiment, the fluorine containing anion is of the formula:

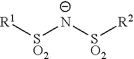

wherein each of R¹ and R² is independently C₁₋₂₀ alkyl or C₁₋₂₀ fluoroalkyl, typically C₁₋₁₀ alkyl or fluoroalkyl, often C₁₋₅ alkyl or fluoroalkyl,
provided at least one of R¹ or R² is C₁₋₂₀ fluoroalkyl. In some instances at least one of R¹ or R² is a C₁₋₅ perfluoroalkyl.

Still in other embodiments, the aqueous solution further comprises a non-aqueous solvent. Typically, the non-aqueous solvent is miscible with water such that the resulting solvent forms a homogeneous solvent. In some instances, the non-aqueous solvent is selected from the group consisting of an alcohol, a linear ether, a cyclic ether, an ester, a carbonate, a formate, a phosphate, a lactone, a nitrile, an amide, a sulfone, a sulfolane, and either a cyclic or an acyclic alkyl carbonate or methyl formate.

Another aspect of the invention provides an aqueous rechargeable zinc-metal battery comprising:
(a) a zinc-metal anode;
(b) a cathode; and
(c) an aqueous electrolyte comprising:
   (i) a zinc-ion based electrolyte comprising zinc ion and a first fluorine containing anion; and
   (ii) a secondary salt comprising a cation and a second fluorine containing anion,
      wherein the coulombic efficiency of said rechargeable zinc-metal battery is at least about 99% after 5 recharging cycle.

In some embodiments, the rechargeable zinc-metal battery is capable of being recharged for at least about 50 cycles, typically at least about 100 cycles, often at least about 200 cycles, and more often at least about 300 cycles.

Yet in other embodiments, the ratio of the metal (e.g., lithium) salt of the fluorine containing anion to the zinc-ion based electrolyte is at least about 10 to 1, typically at least about 15:1, and often at least about 20:1.

In some embodiments, the cathode comprises LiMn₂O₄, O₂, or a material selected from the group comprising oxides, sulfides, selenides, LiₓMn₂O₄ (x is an integer from 0 to 2), LiₓMnO₂ (x is an integer from 0 to 2), LiₓCoO₂ (x is 0 or 1), LiₓFePO₄ (x is 0 or 1), LiₓV₂(PO₄)₃ (x is an integer from 0 to 2), LiₓVPO₄F (x is an integer from 0 to 2), V₂O, V₆O₃, V₅S₈, TiS₂, LiₓV₃O₈ (x is an integer from 0 to 2), V₂S₅, NbSe₃, LiₓNiO₂ (x is 0 or 1), LiₓNi_{y}Co_{z}O₂ (x is an integer from 0 to 2, each of y and z is independently 0 or 1), LiₓNi_{y}Mn_{z}O₂ (x is an integer from 0 to 2, each of y and z is independently 0 or 1), LiₓCo_{y}Mn_{z}O₂ (x is an integer from 0 to 2, each of y and z is independently 0 or 1), MoS₂, chromium oxides, molybdenum oxides, niobium oxides, electronically conducting polymers including polypyrrole, polyaniline, polyacetylene, and polyorganodisulfides including poly-2,5-dimercaptol,3,4-thiadiazole, and other forms of organosulfides, and the like, or a combination of two or more thereof.

Yet in other embodiments, the fluorine containing anion is of the formula:

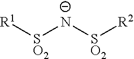

wherein each of R¹ and R² is as defined herein (e.g., C₁₋₂₀ alkyl or C₁₋₂₀ fluoroalkyl, provided at least one of R¹ or R² is C₁₋₂₀ fluoroalkyl).

In one particular embodiment, the fluorine containing anion comprises trifluorosulfonylimide, bis(fluorosulfonyl)imide, trifluoromethanesulfonate, 4,5-dicyano-2-(trifluoromethyl) imidazole or other longer chains. As stated herein, the first and the second fluorine containing anion can be independently selected.

Still in another embodiment, the aqueous electrolyte has pH of about 7.

### BRIEF DESCRIPTION OF THE DRAWINGS

FIG. 1A is galvanostatic graph of Zn stripping/plating in a Zn/Zn symmetrical cell at 0.2 mA/cm² using one particular embodiment of an electrolytic solution of the present invention.

FIG. 1B is a scanning electron microscope (SEM) image and XRD pattern (inset) of a Zn anode after 500 stripping/plating cycles in one particular electrolytic solution of the present invention.

FIG. 1C is a cyclic voltammogram (CV) of Zn plating/stripping using one particular embodiments of an electrolytic solution of the invention in a three-electrode cell using a Pt disc (2 mm in diameter) as working and Zn as reference and counter electrodes at scan rate of 1 mV/s.

FIG. 1D is a graph of Zn plating/stripping time (left) and columbic efficiency (right) using one particular embodiment of an electrolytic solution of the invention on a Pt working electrode at 1 mA/cm².

FIG. 1E is a graph of Zn stripping/plating from Zn/Zn symmetrical cells at 0.2 mA/cm² in a 6 M KOH alkaline electrolyte.

FIG. 1F is an XRD spectrum of a Zn anode after 100 cycles in the 6 M KOH alkaline electrolyte.

FIG. 2A is a graph showing pH values of electrolytes with varying lithium salt concentrations.

FIG. 2B is a graph showing the progression of FTIR spectra between 3800 and 3100 cm¹ at varying lithium salt concentrations.

FIG. 2C is a graph showing change of chemical shifts for ¹⁷O-nuclei in solvent (water) at various lithium salt concentrations.

FIG. 2D is a graph showing the weight retention of different electrolytes in the air with relative humidity of ˜65%.

FIG. 3 shows a typical voltage profile of Zn/LiMn₂O₄ full cell in the HCZE (1 m Zn(TFSI)₂+20 m LiTFSI) at 0.2 C (Zn—LiMn₂O₄ mass ratio 0.25:1).

FIG. 4: The electrochemical performance of Zn/LiMn₂O₄ full-cell. a, The typical voltage profile of Zn/LiMn₂O₄ full-cell in HCZE (1 m Zn(TFSI)₂+20 m LiTFSI) at constant current (0.2 C, real capacity of LiMn₂O₄: 2.4 mAh/cm²). The cycling stability and coulombic efficiency of Zn/LiMn₂O₄ full-cell in HCZE at b, 0.2 C and c, 4 C rates. d, Storage performance evaluated by resting 24 hours at 100% SOC % after 10 cycles at 0.2 C, followed by full discharging.

FIG. 5A: The electrochemical performance of aqueous Zn/O₂ full-cell. Typical full range voltage profile of the Zn/O₂ battery in HCZE (1 m Zn(TFSI)₂+20 m LiTFSI) using 70 wt. % super P as the air cathode at a constant current of 50 mA/g (based on the cathode) between 0.5 V-2.0 V; inset is the corresponding cycling performance.

FIG. 5B: The electrochemical performance of aqueous Zn/O₂ full-cell. Cycling performance of the Zn/O₂ battery at a current density of 50 mA/g under constant capacity mode (1000 mAh/g, the areal capacity of cathode: 0.7 mAh/cm²).

FIG. 6A is a cyclic voltammogram (CV) of Zn plating/stripping in a three-electrode cell using a Pt as a working electrode and a Zn metal as reference and counter electrode in a 6 M KOH alkaline electrolyte.

FIG. 6B is a graph of columbic efficiency of Zn metal plating/stripping in a 6 M KOH alkaline electrolyte.

FIG. 7A is a cyclic voltammogram (CV) of Zn plating/stripping in a three-electrode cell using a Pt as a working electrode and a Zn metal as reference and counter electrode in a 2 M ZnSO₄ electrolyte.

FIG. 7B is a graph of columbic efficiency of Zn metal plating/stripping in a 2 M ZnSO₄ electrolyte.

FIG. 8A is a cyclic voltammogram (CV) of Zn plating/stripping in a three-electrode cell using a Pt as a working electrode and a Zn metal as reference and counter electrode in a 2 M Zn(Ac)₂ electrolyte.

FIG. 8B shows columbic efficiency of Zn metal plating/stripping in a 2 M Zn(Ac)₂ electrolyte.

FIG. 9 is voltage profiles of Zn plating/stripping on a Pt working electrode at 1 mA/cm² in the HCZE (1 m Zn(TFSI)₂+20 m LiTFSI) during the first 10 cycles.

FIGS. 10A-C show CEs of Zn metal plating/stripping on a Pt working electrode in the electrolytes at 5 m, 10 m, and 15 m LiTFSI concentrations, respectively, at 1 mA/cm².

### DETAILED DESCRIPTION OF THE INVENTION

One aspect of the present invention provides an electrolyte for a rechargeable zinc-metal anode battery. The electrolyte of the present invention includes an aqueous solution having a pH of from about 3 to about 7, typically about pH 4 to about pH 7, often about pH5 to about pH7, and more often about pH 6 to about pH 7; a zinc-ion based electrolyte comprising zinc ion and a first fluorine containing anion; and a secondary salt that comprises a cation (e.g., a metal ion such as lithium ion) and a second fluorine containing anion. It should be appreciated that the secondary salt is different from the electrolyte of zinc ion and the first fluorine containing anion. Thus, when the first and the second fluorine containing anions are the same, the metal ion of the secondary salt cannot be zinc. However, when the first and the second fluorine containing anions are different, then the metal ion of the secondary salt can be zinc ion.

The aqueous solution of used in the electrolytic solution of the invention can also include other non-aqueous solvents including, but not limited to, an alcohol, a linear ether, a cyclic ether, an ester, a carbonate, a formate, a phosphate, a lactone, a nitrile, an amide (such as dimethylformamide or DMF), a sulfone, a sulfolane, a cyclic or acyclic alkyl carbonate, methyl formate, and other organic solvents that are well known to one skilled in the art. In some embodiments, the aqueous solution can also include other organic solvents as long as it forms a homogenous solution. Some specific examples of organic solvents that can be used in electrolytic solutions of the invention include, but are not limited to, propylene carbonate (PC), dimethyl carbonate (DMC), trimethyl phosphate (TMP), dimethylsulfoxide (DMSO), dimethylformamide (DMF), and the like.

Typically, the pH of the electrolytic solution is non-alkali, e.g., about pH 8 or less, typically, about pH 3 to about pH 7, often about pH 4 to about pH 7, more often about pH 5 to about pH 7, and most often about pH 7. Without being bound by any theory, by keeping the pH of the electrolytic solution at near neutral or below alkaline, it is believed that the formation of zincate (e.g., zinc hydroxide) is significantly reduced or substantially completely suppressed.

While the concentration of zinc-ion based electrolyte in the aqueous solution can range widely, surprisingly and unexpectedly, it has been found by the present inventors that a relatively high concentration of zinc-ion electrolyte plays a significant role in overcoming various problems associated with conventional rechargeable Zn-metal batteries. Accordingly, in some embodiments, the concentration of zinc-ion based electrolyte used ranges from about 0.5 mole/kg (m, molality) to about 25 m, typically, from about 1 m to about 25 m, often from about 2 m to about 21 m, and more often from about 3 m to about 21 m. When referring to a numerical value, the terms “about” and “approximately” are used interchangeably herein and refer to being within an acceptable error range for the particular value as determined by one of ordinary skill in the art, which will depend in part on how the value is measured or determined, e.g., the limitations of the measurement system, i.e., the degree of precision required for a particular purpose. For example, the term “about” typically means within 1 standard deviation, per the practice in the art. Alternatively, the term “about” can mean±20%, typically ±10%, often ±5% and more often ±1% of the numerical value. In general, however, where particular values are described in the application and claims, unless otherwise stated, the term “about” means within an acceptable error range for the particular value.

Surprisingly and unexpectedly, it has been found by the present inventors that the ratio of zinc-ion based electrolyte to the metal salt also plays a significant role in the electrolytic solution's ability to retain water in open atmosphere, promotes dendrite-free plating/stripping of Zn, the coulombic efficiency (“CE”), and reversibility to aqueous Zn chemistries, i.e., rechargeability of the battery. Thus, in some embodiments, the ratio of the metal salt of the fluorine containing anion to the zinc-ion based electrolyte is at least about 5:1, typically at least about 10:1, often at least about 15:1, and more often at least about 20:1.

The cation of the secondary salt can be an alkaline metal ion (e.g., Na, Li, K, Cs, etc.), an alkaline metal ion (e.g., Mg, Ca, Sr, Ba, etc.), a transition metal ion (e.g., Ti, V, Cr, Mn, Fe, Co, Ni, Cu, Cd, etc.), other cations such as NH₄⁺, and other cations that together with the second fluorine containing anion can form an ionic liquid. In some embodiments, the cation of the secondary salt is not a zinc ion. Typically, the cation of the secondary salt is a cation selected from the group consisting of Li⁺, Na⁺, K⁺, NH₄⁺, Mg²⁺, and Ca²⁺. Often the cation of the secondary salt is a cation selected from the group consisting of Li⁺, Na⁺, K⁺, NH₄⁺, and Mg²⁺. And most often the cation of the secondary salt is a cation selected from the group consisting of Li⁺, Na⁺, K⁺, and NH₄⁺.

When referring to electrochemistry or battery, the terms “rechargeable” and “reversibility” are used synonymously and refer to an ability of the battery to be recharged for at least about 50 cycles, typically at least about 100 cycles, often at least about 200 cycles, and more often at least about 300 cycles. The terms “charge” and “charging” refer to process of increasing electrochemical potential energy of an electrochemical cell by providing electrical energy to the electrochemical cell. It is to be understood that the terms “battery,” “cell,” and “electrochemical cell” are used interchangeable herein and refer to a device that converts chemical energy into electrical energy, or electrical energy into chemical energy. Generally, electrochemical cells have two or more electrodes and an electrolyte, where electrode reactions occurring at the electrode surfaces result in charge transfer processes. Examples of electrochemical cells include, but are not limited to, batteries and electrolysis systems. A “battery” may consist of a single cell or a plurality of cells arrangement in series and/or in parallel to form a battery module or a battery pack. In present invention, secondary batteries (i.e. rechargeable batteries) are of particular interest. For the purposes of illustration and brevity, it is also to be understood that while present disclosure has been described in detail with respect to Zn-anode rechargeable batteries, the scope of the invention is not limited as such.

Another key finding by the present inventors is the fluorine containing anion significantly reduces or eliminates various shortcomings of the conventional aqueous Zn-metal rechargeable batteries. Without being bound by any theory, the fluorine containing anions of the invention are believed to provide unique solvation sheath structure of Zn²⁺, particularly in the highly-concentrated aqueous electrolyte. It is also believed that the high population of fluorine containing anions forces themselves into the vicinity of Zn²⁺, forming close pair with zinc-ion, thereby significantly suppressing the presence or formation of [Zn—(H₂O)₆]²⁺. In conventional aqueous solution, Zn²⁺ cations are solvated by dipolar water molecules, giving rise to aqua-ions [Zn(OH₂)₆]²⁺, i.e., hydrated zinc ion. Again without being bound by any theory, it is believed that suppressing formation of hydrated zinc-ion results in dendrite-free Zn morphology containing minimal (i.e., no more than about 10%, typically no more than about 5%, and often no more than 1 or 2%) or substantially no ZnO. This suppression of zinc hydrate formation provides a novel method for achieving highly efficient utilization of Zn for advanced energy storage applications with intrinsic safety, with potential application on other multi-valent cations that are often plagued with poor reversibility and sluggish kinetics.

As stated above, the fluorine containing anion suppresses hydrolysis of zinc-ion or formation of hydrated zinc-ion, zinc oxide, zinc hydroxide, or a combination thereof. Since formation of hydrated zinc-ion is significantly reduced or eliminated by using the fluorine containing anion of the invention, there is no need to replenish water in the electrolyte. More significantly, the resulting electrolyte is capable of retaining water in open atmosphere. In some embodiments, the zinc-ion based electrolyte of the present invention provides dendrite-free plating/stripping of Zn anode at a coulombic efficiency of at least about 90%, typically at least about 95%, often at least about 98%, more often at least about 99%, and most often at 100%.

In some embodiment, the fluorine containing anion comprises a fluoroalkylsulfonyl group, i.e., a moiety of the formula: R—SO₂—, where R is a fluoroalkyl group of 1 to 20, typically 1 to 10, and often 1 to 5 carbons, such as trifluoromethyl, difluoromethyl, perfluoroethyl, perfluoropropyl, fluoroethyl, difluoroethyl, etc. Other fluorine containing anions that are useful in the present invention include, but are not limited to, 4,5-dicyano-2-(trifluoromethyl)imidazolium (“TDI”), or an imidazolium anion of the formula:

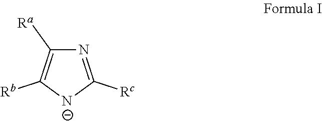

where each of R^{a}, R^{b}, and R^{c} is independently hydrogen, C₁₋₆ alkyl, C₁₋₆ fluoroalkyl, halide, cyano, provided at least one of R^{a}, R^{b}, and R^{c} is fluoride or C₁₋₆ fluoroalkyl. Other fluoride containing anions that can be used in the present invention include trifluoroacetate, triflate (i.e., CF₃SO₃⁻), trifluorosulfonylimide, and bis(fluorosulfonyl)imide. The term “alkyl” refers to a saturated linear monovalent hydrocarbon moiety or a saturated branched monovalent hydrocarbon moiety. Exemplary alkyl group include, but are not limited to, methyl, ethyl, n-propyl, 2-propyl, tert-butyl, pentyl, and the like. The term “fluoroalkyl” refers to an alkyl group in which at least one of the hydrogen is replaced with fluoride including perfluoroalkyls. Exemplary fluoroalkyl group include, but are not limited to, fluoromethyl, difluoromethyl, trifluoromethyl, 2,2,2-trifluoroethyl, 1-fluoroethyl, pentaluoroethyl or perfluoroethyl, 1-trifluoromethylethyl, and the like.

In some embodiments, the fluoride containing anion comprises C₁₋₅ perfluoroalkyl group, such as but not limited to, trifluormethyl, pentafluoroethyl, heptafluoropropyl, heptafluoro-isopropyl, etc.

In one particular embodiment, the fluorine containing anion is of the formula:

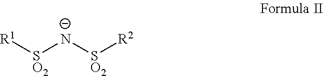

where R¹ and R² are as defined herein. In one particular embodiment, each of R¹ and R² is independently C₁₋₅ alkyl or C₁₋₅ fluoroalkyl, provided at least one of R¹ or R² is C₁₋₅ fluoroalkyl. In some instances, at least one of R¹ or R² is a C₁₋₅ perfluoroalkyl. In one specific embodiment, R¹ and R² are trifluoromethyl.

It should be appreciated however, the fluorine containing anion is not limited to the fluorine containing anions disclosed herein. In general, any fluorine containing anion can be used in the invention, as long as the fluorine containing anion is stable in the water and can dissolve in the water.

The electrolytes of the invention are useful in an aqueous rechargeable zinc-metal anode. Typically, the aqueous rechargeable zinc-metal battery comprises:
(a) a zinc-metal anode;
(b) a cathode; and
(c) the aqueous electrolyte of the invention as described herein.

Using the electrolyte of the present invention results in an aqueous rechargeable zinc-metal battery having the coulombic efficiency of at least about 90%, typically at least about 95%, and often at least about 98% even after 100 recharging cycles. In some embodiments, use of the electrolyte of the present invention results in a rechargeable zinc-metal battery that is capable of being recharged for at least about 100 cycles, typically at least about 200 cycles, often at least about 300 cycles, and more often at least about 500 cycles.

While any of the known metals/materials can be used as the cathode, in one particular embodiment, the cathode comprises an oxide, a sulfide, a selenide, or a combination thereof. Exemplary cathodes or cathode materials that are useful in the present invention include, but are not limited to, LiMn₂O₄, O₂, or a material selected from the group consisting of an oxide, a sulfide, and a selenide, LiₓMn₂O₄, LiₓMnO₂, LiₓCoO₂, LiₓFePO₄, LiₓV₂(PO₄)₃, LiₓVPO₄F, V₂O₅, V₆O₃, V₅S₈, TiS₂, LiₓV₃O₈, V₂S₅, NbSe₃, LiₓNiO₂, LiₓNi_{y}Co_{z}O₂, LiₓNi_{y}Mn_{z}O₂, LiₓCo_{y}Mn_{z}O₂, MoS₂, a chromium oxide, a molybdenum oxide, a niobium oxide, an electronically conducting polymer, such as a polypyrrole, a polyaniline, a polyacetylene, and a polyorganodisulfide (e.g., poly-2,5-dimercaptol,3,4-thiadiazole), and other forms of organosulfides, and the like, and a combination of two or more thereof. The variable x, y, and z are those defined herein.

Additional objects, advantages, and novel features of this invention will become apparent to those skilled in the art upon examination of the following examples thereof, which are not intended to be limiting. In the Examples, procedures that are constructively reduced to practice are described in the present tense, and procedures that have been carried out in the laboratory are set forth in the past tense.

### Examples

This example shows results of a highly-concentrated Zn-ion electrolyte (denoted as HCZE hereafter) with a supporting salt, i.e., secondary salt, at high concentration. An aqueous solution of 1 m Zn(TFSI)₂ and 20 m LiTFSI, (where m is molality, mol/kg, and TFSI denotes trifluoromethylsulfonimide), was prepared and used as an electrolyte. This solution had a neutral in pH and was capable of retaining water in open atmosphere, promoted dendrite-free plating/stripping of Zn at nearly 100% CE, and provided reversibility to aqueous Zn chemistries with either LiMn₂O₄ or O₂ cathodes. The former was shown to deliver 180 Wh/kg and retained 80% of its capacity for >4000 cycles, while the latter delivered 300 Wh/kg for >200 cycles. Combining structural and spectroscopic studies with molecular-scale modeling, appeared to indicate that this excellent Zn-reversibility stemmed from the unique solvation sheath structure of Zn²⁺ in the highly-concentrated aqueous electrolyte, where the high population of anions forces themselves into the vicinity of Zn²⁺, forming close ion-pairs, i.e., [Zn-TFSI]⁺, thereby significantly suppressing the formation/presence of [Zn—(H₂O)₆]²⁺. This fundamental understanding allows a new avenue to the highly efficient utilization of Zn for advanced energy storage applications with intrinsic safety, with applications on other multi-valent cations that are often plagued with poor reversibility and sluggish kinetics.

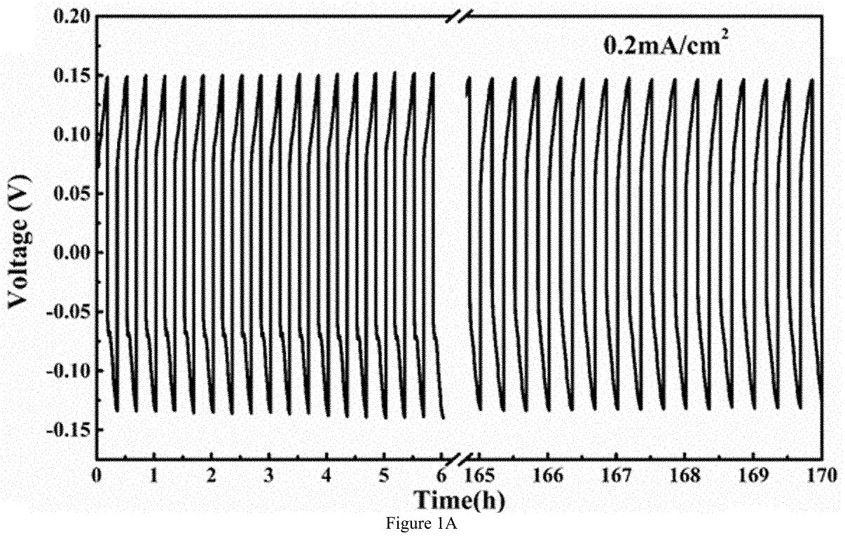

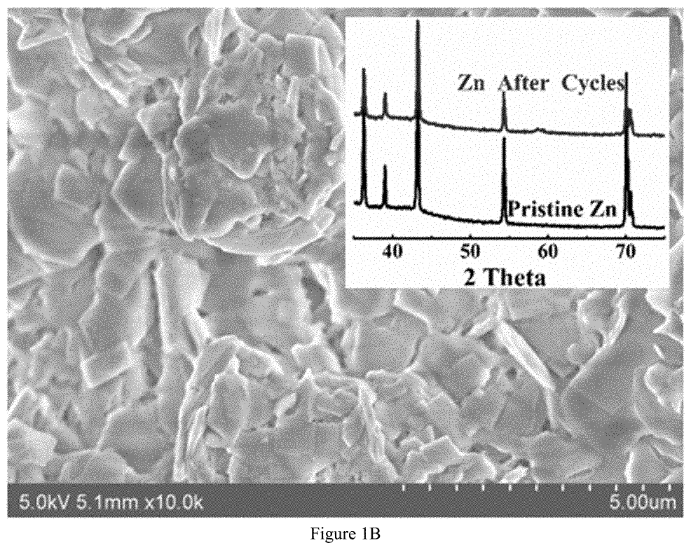

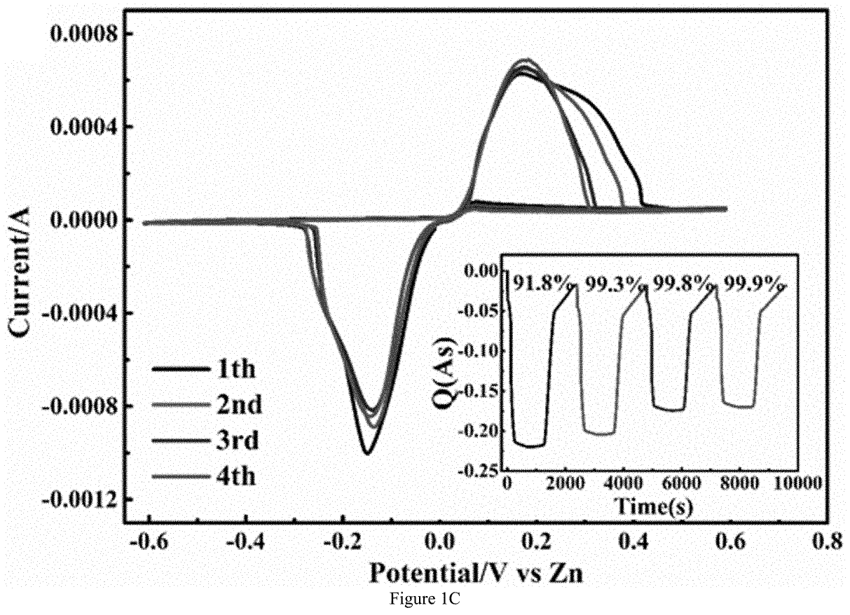

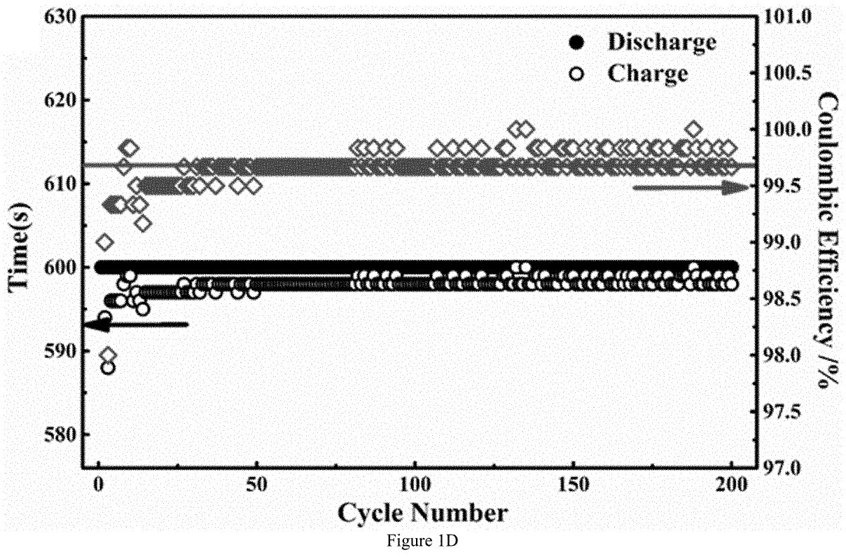

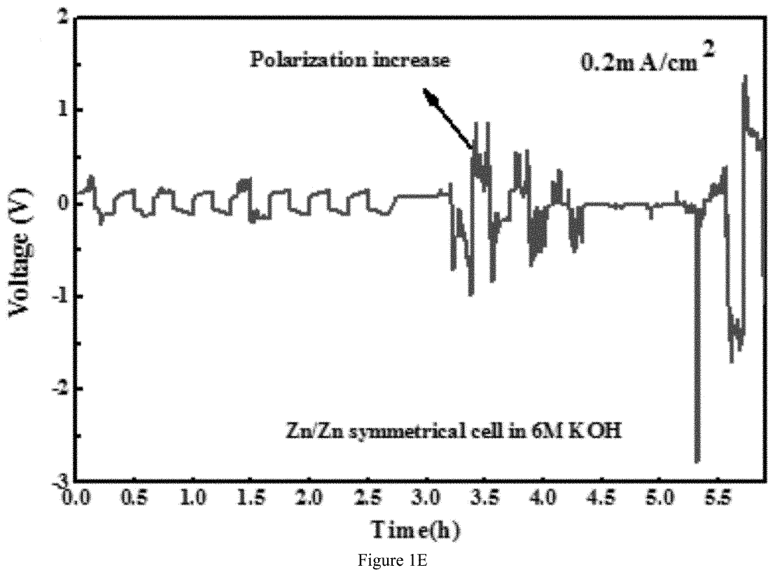

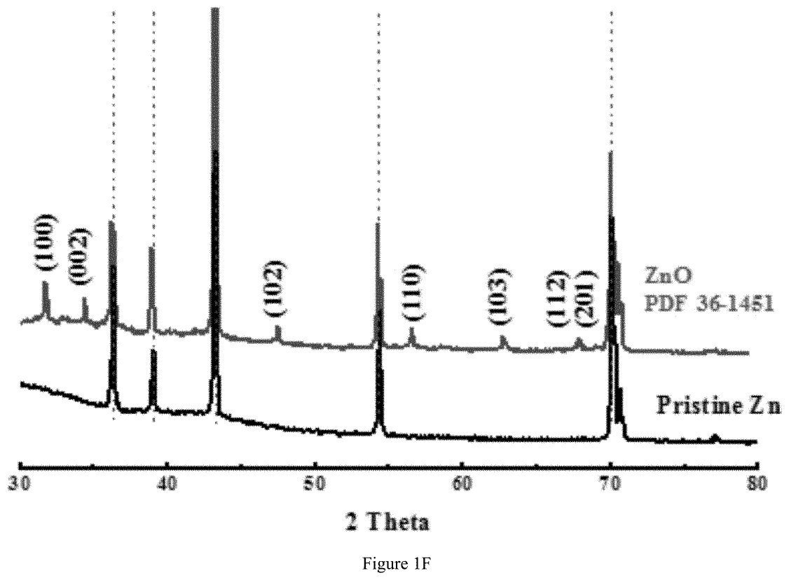

The reversibility and stability of Zn in HCZE (1 m Zn(TFSI)₂+20 m LiTFSI) were investigated using a Zn/Zn symmetric cell under galvanostatic condition (FIG. 1A). After >500 cycles (which took >170 hours), the Zn plated on substrates still exhibited a dense and dendrite-free morphology (FIG. 1), which contained no observable ZnO according to X-ray diffraction (XRD) (inset FIG. 1). In sharp contrast, in an alkaline electrolyte solution (6 M KOH), a sudden polarization occurred after only six stripping/plating cycles (FIG. 1E) due to intensified Zn-dendrite formation, which shorted the cell within 5.3 hours. The formation of a ZnO layer was detected by XRD on this cycled Zn surface (FIG. 1F).

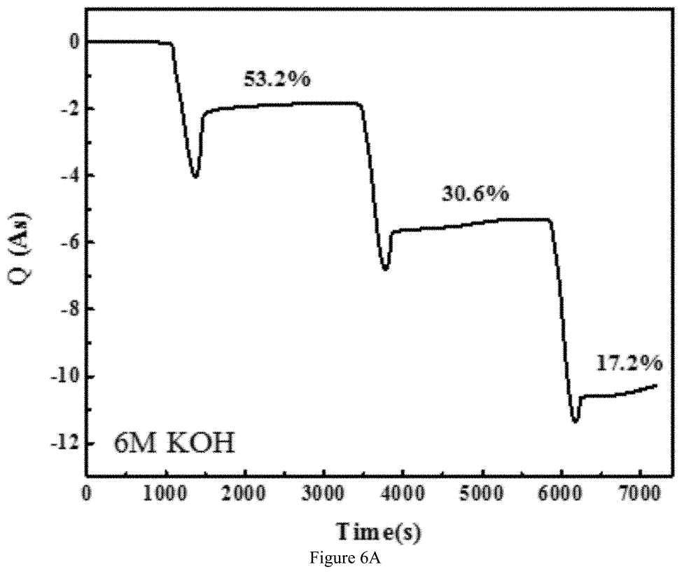

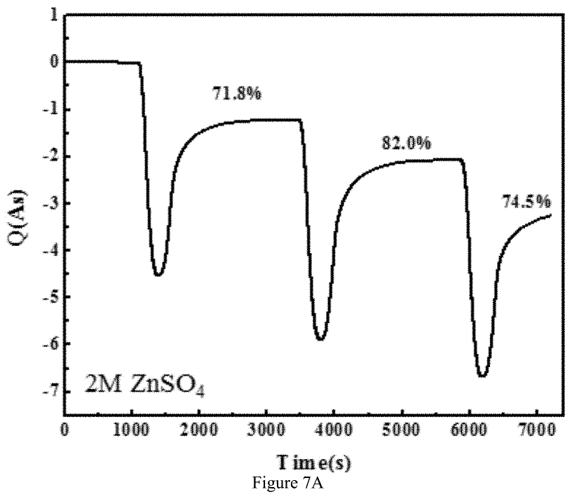

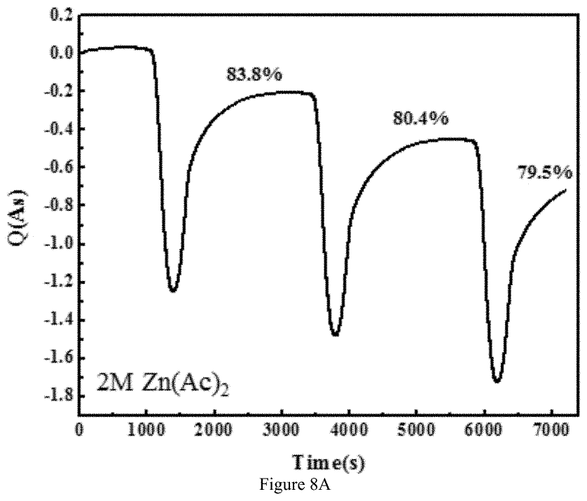

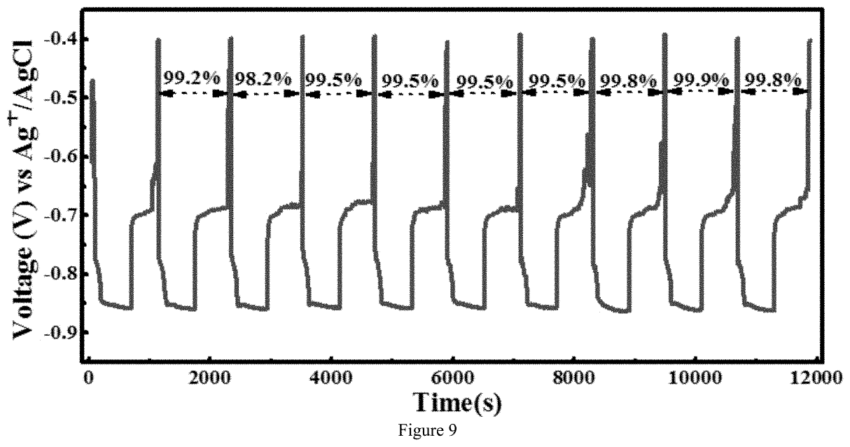

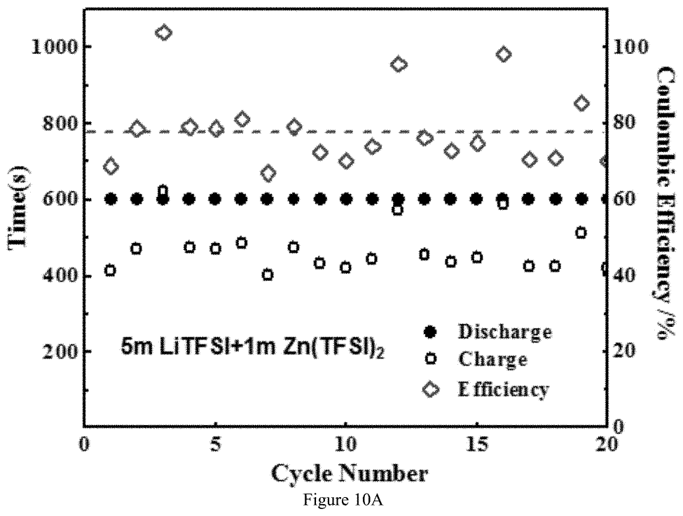

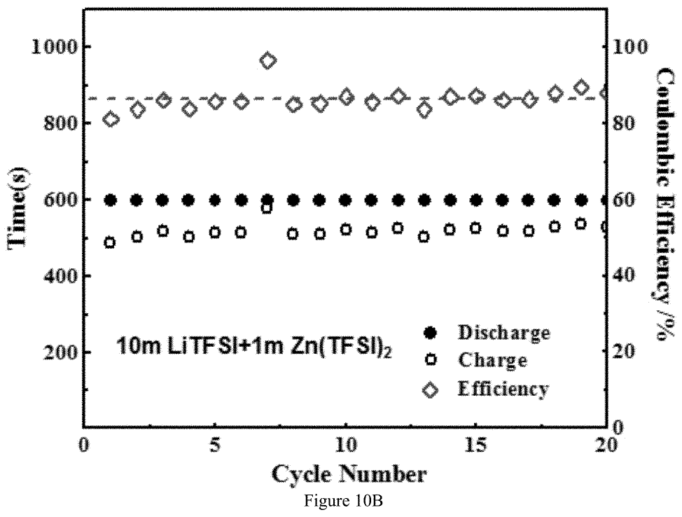

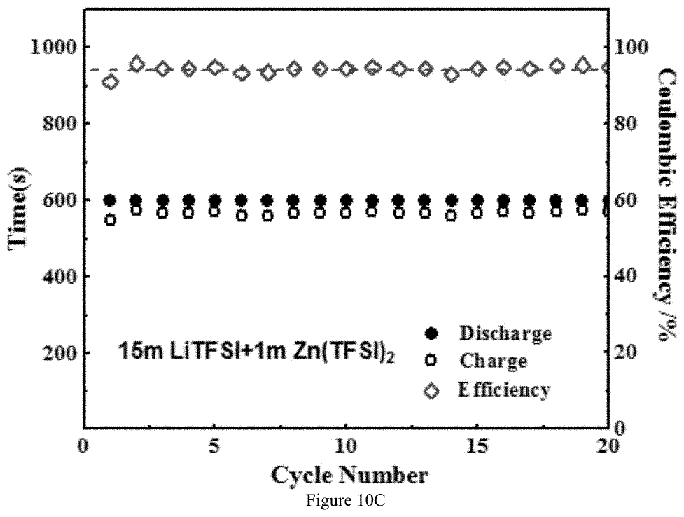

The reversibility of Zn plating/stripping in HCZE were further investigated using cyclic voltammetry (CV), where a Pt disk (2 mm in diameter) was used as working and Zn as reference and counter electrodes in a three-electrode cell. Chronocoulometry curves (FIG. 1C inset) revealed that the plating/striping was highly reversible with CE approaching 100% after the second cycle. Again in sharp contrast, CE in alkaline electrolytes was <50% (FIG. 6A) under identical conditions. Alternatively, in mildly acidic aqueous electrolytes (2 M ZnSO₄ and 2 M Zn(CH₃COO)₂), higher CEs of 75% and 80%, respectively, were obtained (FIGS. 7A and 8A, respectively), but still significantly inferior when compared to HCZE. Pt/Zn coin cells were also used to evaluate the reversibility of Zn plating/stripping, whose CE, calculated from the ratio of Zn removed from Pt substrate to that deposited during the same cycle, gradually increased and reached 99.5% after the first 3 cycles (FIG. 9). Surprisingly and unexpectedly, a stable CE of >99.7% was maintained for >200 cycles, which suggests that essentially all Zn deposited on the substrate could be recovered during the following stripping process. In some instances, CEs were found to be sensitive to LiTFSI concentrations in HCZE, where they steadily increased from ˜80% at 5 m LiTFSI to ˜96% at 15 m LiTFSI (see FIGS. 10A-10C). Without being bound by any theory, it is believe that the high TFSI concentration, which amounts to 22 m (1 m Zn(TFSI)₂+20 m LiTFSI), is directly responsible for the high CE of Zn in HCZE.

Zn²⁺ Solvation Sheath Structure:

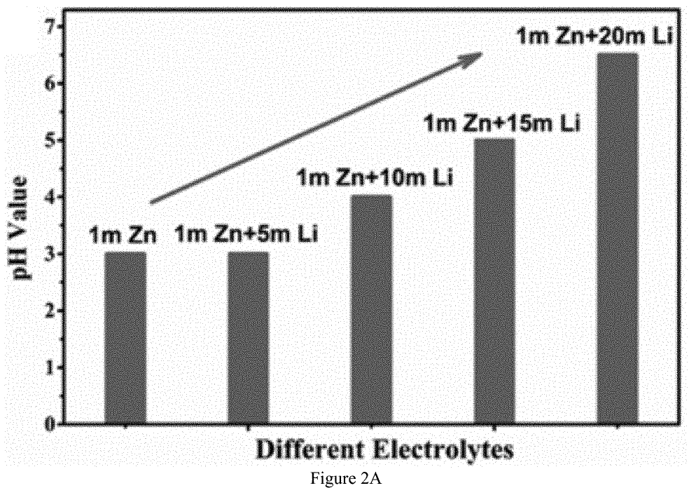

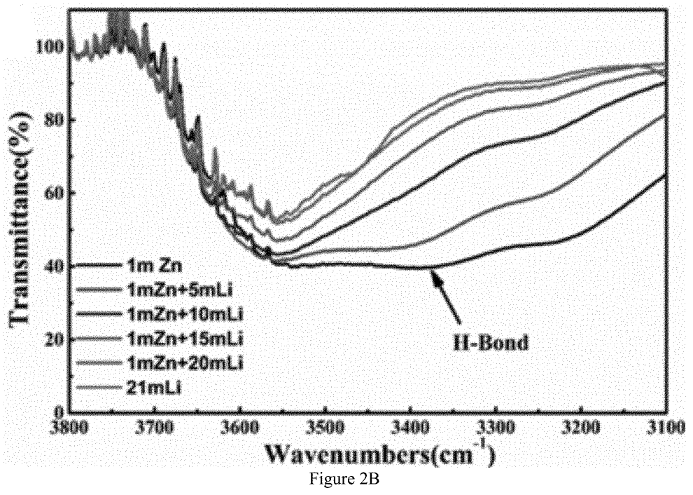

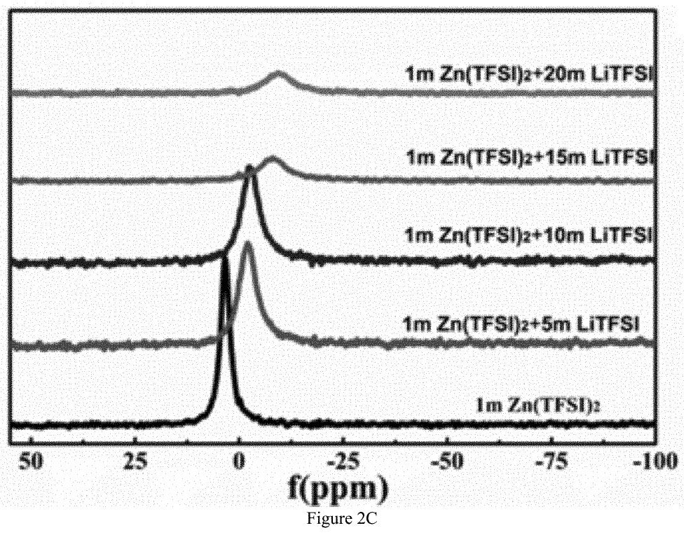

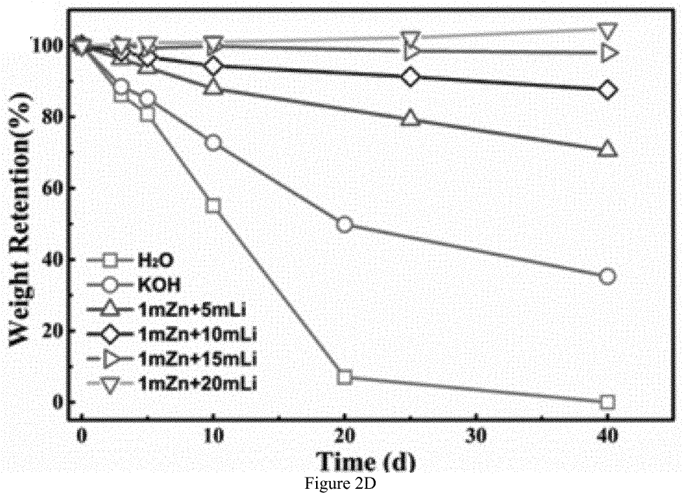

It is believed that in aqueous solutions, Zn²⁺ cations are solvated by dipolar water molecules, giving rise to aqua-ions [Zn(OH₂)₆]²⁺ as long as there are enough water molecules available. Such cation-solvent interaction has profound effect on the pH of the resultant solutions, because for the solvated Zn²⁺, charge transfer occurs via the M-OH₂ bond, with electron departing the 3a₁ bonding molecular-orbital of coordinated water for empty Zn²⁺-orbitals, resulting in a significantly weakened O—H bond within the water molecule. In dilute aqueous solutions, deprotonation can ensue, generating an acidic solution along with a series of more or less deprotonated monomeric species, ranging from aqua-ions [Zn(OH₂)₆]²⁺ to hydroxyl species Zn(OH)₂ or even oxo-anions ZnO when all protons are removed from the coordination sphere of metal cation. As shown in FIG. 2A, the electrolyte pH values steadily increase with LiTFSI concentration, from pH=3 at 1.0 m Zn(TFSI)₂, where the strong interaction of Zn²⁺ with H₂O leads to hydrolysis, all the way to approaching pH˜7 in HCZE, where the near neutrality indicates the effective suppression of hydrolysis. The interplay among Zn²⁺, TFSI⁻ and water was quantified using FTIR and NMR spectroscopies. A strong band In FTIR at ˜3552 cm⁻¹ (FIG. 2B) together with a small shoulder at ˜3414 cm⁻¹ arise for the dilute concentration (1 m Zn(TFSI)₂+5 m LiTFSI), where the peak at 3414 cm⁻¹ is attributed to the weak hydrogen-bonding of H₂O, indicating the aggregation of water molecules. At a salt concentration of ˜10 m, the 3414 cm⁻¹ peak almost disappears, indicating the extensive disruption of water network connected via hydrogen-bonding. The ¹⁷O-chemical shift of water signal (˜0 ppm) in NMR (FIG. 2C) serves as a sensitive indicator for its coordination with salt ions. With increasing salt concentration, the ¹⁷O-signal starts a downshift, because the lone pair electrons on water O is directly depleted by the Li⁺ cation, which deshields the O-nucleus. This effect intensified when the salt concentration increased to ˜10 m. Based on both FTIR and ¹⁷O-NMR, it is believed that, at high Li⁺ concentrations, water molecules may have been confined within the Li⁺ solvation structures, and the presence of water in the vicinity of Zn²⁺ has severely diminished. This weakened Zn-water interaction essentially eliminated the hydrolysis effect, as evidenced by the neutral pH value.

FIG. 2D demonstrates the weight retention of the electrolytes with varying LiTFSI concentrations when exposed to the open atmosphere. A sharp contrast exists between the dilute (˜5 m LiTFSI) and the concentrated (10 m LiTFSI and up) electrolytes. The most concentrated electrolyte (1 m Zn(TFSI)₂+20 m LiTFSI) not only retained water content for more than 40 days, but also experienced a slight weight increase, indicating that the electrolyte actually appears to extract moisture from the ambient. This unique feature effectively removes the traditional concern of aqueous Zn electrolytes that regularly require replenishing, and renders the cell with unprecedented flexibility in form-factor and durability.

Molecular Dynamics Studies:

Molecular dynamics (MD) simulations were performed using the polarizable APPLE&P force field on aqueous electrolytes that consisted of 1 m Zn(TFSI)₂, and LiTFSI at three concentrations (5 m, 10 m and 20 m) as a function of temperature. Due to much stronger binding of water and TFSI⁻ by Zn²⁺ as compared to Li⁺, longer residence time of TFSI in the vicinity of Zn²⁺ was observed as compared to the Li⁺/TFSI-relaxation. Thus, a sequence of MD simulation runs from 450K (overheated system) to 393K and 363K was performed to accelerate dynamics, and to ensure that the equilibrium Zn²⁺-solvation sheath structure was obtained. Due to higher thermal fluctuations at these temperatures (393 K and 450 K), Zn²⁺ relaxation is significantly faster, and the resultant Zn²⁺-solvation sheath structures are adequately converged. In the most dilute electrolyte (1 m Zn(TFSI)₂+5 m LiTFSI), Zn²⁺ is expected to coordinate with 6 water molecules without much contribution from the TFSI. This finding is in accord with DFT calculations performed on the Zn(TFSI)ₘ(H₂O)ₙ clusters immersed in implicit water solvent, which revealed the preference of Zn²⁺ to coordinate water instead of TFSI in dilute solutions. At the intermediate LiTFSI concentration (1 m Zn(TFSI)₂+10 m LiTFSI), it appears anions start to occupy the Zn²⁺-solvation sheath resulting in a temperature dependent composition of the Zn²⁺ solvation shell. In other words, for the electrolytes of intermediate concentrations, increasing temperature favors the formation of cation-anion aggregates that could be beneficial for the anion reduction instead of water. In the most concentrated electrolyte, (1 m Zn(TFSI)₂+20 m LiTFSI), the Zn²⁺-solvation sheath is primarily occupied by TFSI, with 6 coordinating oxygens all from TFSI. Small angle neutron scattering (SANS) measurements were performed to validate the intermediate range electrolyte structures predicted by MD simulations, which confirmed the position and shape of an I(Q) peak at Q≈0.5 A⁻¹, originating largely from the D₂O-D₂O correlations with a minor contribution from the ion-ion interaction.

DFT calculations also predicted that Zn(TFSI)₂(H₂O)₂ clusters found in 1 m Zn(TFSI)₂+10 m LiTFSI electrolyte undergo reduction around 2.55 V vs. Li/Li⁺, resulting in H₂-evolution. TFSI reduction in such clusters would occur at lower potentials (1.6˜2.1 V vs. Li/Li⁺), indicating that H₂-evolution is expected to be the predominant reaction as long as water molecules are present in the Zn²⁺ solvation sheath. In the concentrated electrolyte (1 m Zn(TFSI)₂+20 m LiTFSI), however, water is no longer present in Zn²⁺-solvation sheath, and consequently reduction potential of Zn(TFSI)ₙ solvate is increased. Note that the defluorination-reaction of LiTFSI occurs at a potential above that of H₂-evolution at high TFSI concentrations. This cross-over is critically meaningful for the formation of an effective interphase, whose presence prevents hydrogen evolution at lower potential and enables an almost quantitative plating/stripping chemistry (CE˜100%) of Zn.

Aqueous Zinc LiMn₂O₄ Hybrid Battery:

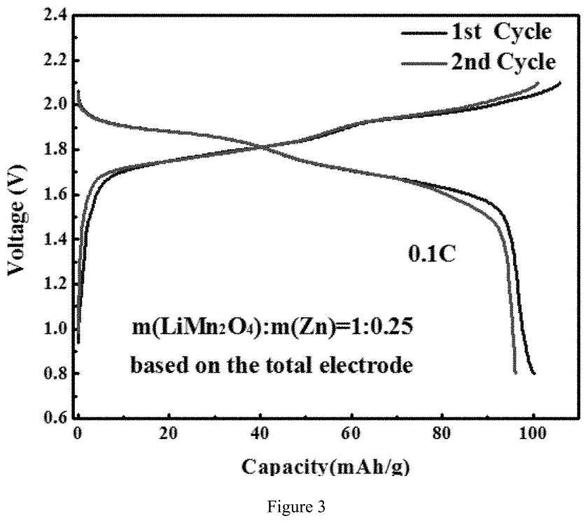

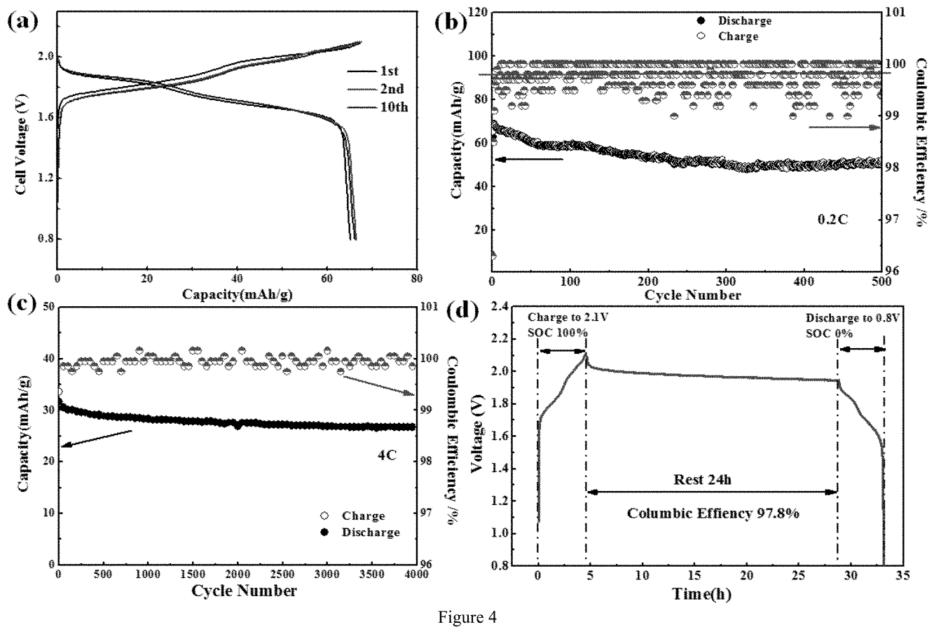

To demonstrate the reversibility of Zn anode in an actual full battery, LiMn₂O₄ was used as cathode to couple with Zn in HCZE and form a hybrid battery, where the well-established Li⁺ intercalation-deintercalation happens at LiMn₂O₄ in a highly reversible manner, while Zn strips/plates at Zn anode. Thus, CE of Zn stripping/plating dictates the overall electrochemical reversibility of this hybrid chemistry. Differing from the frequent practice of Zn batteries, wherein excessive Zn metal has to be used to prevent premature depletion, the mass ratio between Zn and LiMn₂O₄ was set to 0.8:1 in this work to leverage the high Zn stripping/plating CE. FIG. 4a shows the charge/discharge profiles of this hybrid battery at 0.2 C rate, consistent with the typical LiMn₂O₄ charge/discharge profiles. The capacity calculated based on (cathode+anode) mass is 66 mAh/g, corresponding to an energy density of 119 Wh/kg. By further reducing Zn:LiMn₂O₄ mass ratio to 0.25:1, a higher energy density of 180 Wh/kg was achieved (FIG. 3).

The Zn/LiMn₂O₄ full-cell functions with both high cycling stability and high columbic efficiency at low (0.2 C) and high (4 C) rates (FIGS. 4b and 4c). At 0.2 C, excellent stability with a high capacity retention of 83.8% and a CE of 99.9% for 500 cycles were observed; At 4 C, 85% of the initial capacity can still be retained after 4000 cycles, with a high CE of 99.9%. The effect of LiTFSI concentration on the electrochemical performances of Zn/LiMn₂O₄ cells was also investigated. The mass ratio of Zn:LiMn₂O₄ was again set at 0.8:1. For intermediate LiTFSI concentration (1 m Zn(TFSI)₂+15 m LiTFSI), the capacity retention after 100 cycles was 75%, along with an average CE of ˜99%; while at lower LiTFSI concentration (1 m Zn(TFSI)₂+10 m LiTFSI) the capacity retention dropped to 59.5% after 100 cycles with the average CE of ˜97%. In sharp contrast, the cell using dilute electrolyte (1 m Zn(TFSI)₂+5 m LiTFSI) showed a rather low CE of ˜90% during the first 20 cycles, and the capacity rapidly decayed to zero after only 25 cycles. The low CE, rather than Zn-dendrite formation, is considered responsible for the limited cycle number in this case, as no short circuit was observed. Preferably, a nearly 100% CE is required to achieve the long-term cycling stability of zinc batteries, otherwise, excessive Zn metal has to be used to compensate for the incessant Zn consumption, which drives down the actual specific capacity utilization and energy density. The parasitic reactions in Zn/LiMn₂O₄ was evaluated by monitoring the open-circuit-voltage decay of a fully-charged cell during storage and then discharging after 24 hours storage. 97.8% of the original capacity was retained (FIG. 4d), confirming that the parasitic H₂— or O₂-evolutions during storage remain negligible.

An attempt was made to estimate the full-cell energy density on a more practical basis by also including the electrolyte weight. It was found that since the above “Zn—Li” hybrid battery is at discharged state upon assembly, its energy density relies on how much Zn²⁺ is pre-stored in the pristine electrolyte, which is limited by the Zn salt solubility. Thus, full-cell energy density decreases to an unsatisfactory level if all Zn has to be present in the pristine electrolytes. To mitigate this disadvantage, the above limitation was circumvented by assembling the cell in its charged state, i.e., coupling a MnO₂ cathode with a Zn anode. In this configuration, Zn is stored at the anode, while an electrolyte with low Zn salt concentration (0.2 m Zn(TFSI)₂+21 m LiTFSI) was used. When such a Zn/MnO₂ cell experiences the initial discharge, Zn²⁺ dissolves from anode and gradually displaces Li⁺ in the electrolyte, while Li⁺ leaves electrolyte and intercalates into the MnO₂ lattice. Benefitting from the high CE of both Zn stripping/plating and Li⁺-intercalation/de-intercalation, the overall cell reversibility is almost identical to that of the discharged full-cell Zn/LiMn₂O₄, but the energy density could now reach a high level of 70 Wh/kg based on the total weight of anode, cathode and electrolyte.

Highly Reversible Aqueous Zn/O₂ Battery:

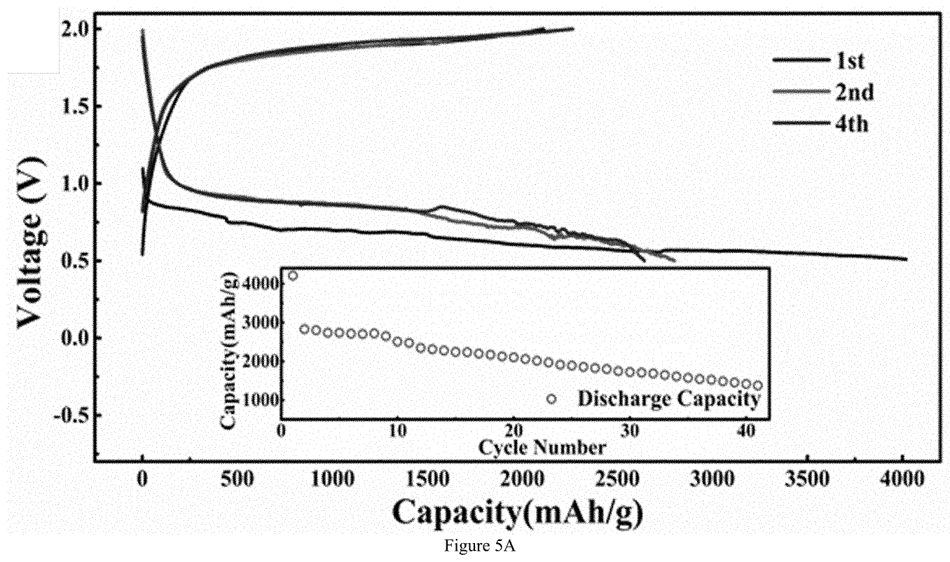

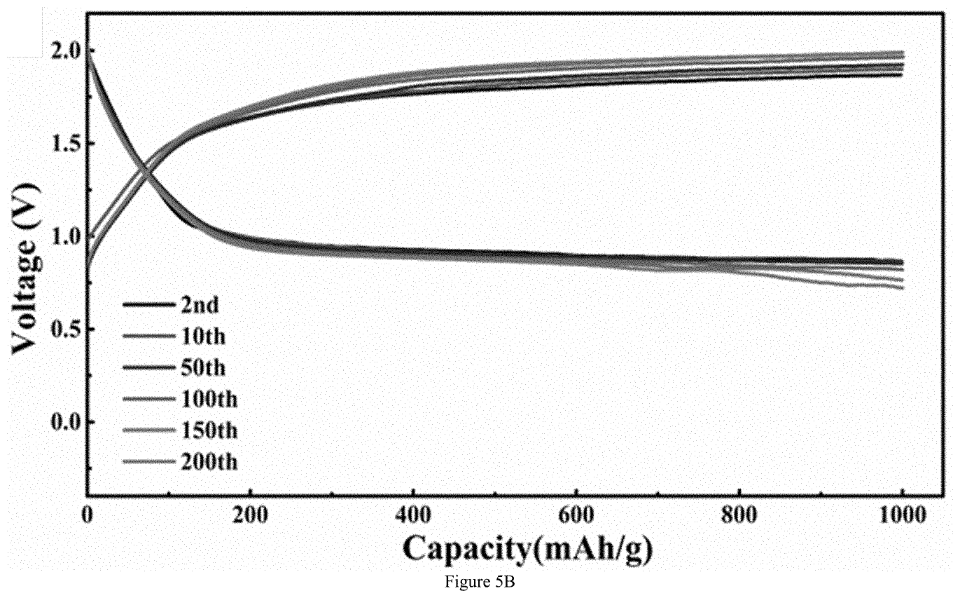

To demonstrate the versatility of HCZE, a Zn/O₂ battery was assembled using Zn as the anode and a porous carbon substrate as air-cathode. Such a chemistry promises an attractive theoretical energy density and has been considered a preferable candidate for large-scale energy storage applications. Although primary Zn-air batteries have been well developed, their rechargeability has always been hindered by poor Zn reversibility as well as inefficient air-cathodes, where the cell reactions must occur at tri-phase sites. Previous efforts at rechargeable Zn/O₂ systems have mainly focused on developing bifunctional catalysts for the air cathode, with limited attention given to electrolytes. Commonly-used alkaline electrolytes are known to induce poor Zn reversibility, and cause significant passivation on the air cathode, mainly due to the presence of atmospheric CO₂. On the other hand, the neutral pH of HCZE simultaneously stabilizes Zn and the air-cathode. Thus, Zn/O₂ cell with a porous air-cathode constructed on carbon paper was examined in the full range between 0.5˜2.0 V at 50 mA/g. Here the specific capacity (mAh/g) and the current density (mA/g) are based on the active materials of O₂-electrodes since the carbon paper is inactive. Such a cell delivered a highly reversible capacity of nearly 3000 mAh/g at an average discharge potential of 0.9 V (FIG. 5A), which, along with the 1.9V charge potential, is superior to most Zn-air batteries reported in alkaline electrolytes. Unlike alkaline electrolytes, where the formation of zincate ions (Zn(OH)₄²⁻) prevails, ZnO was formed instead after the first discharge process, as confirmed by the Raman spectrum. The cell voltage fluctuated when the cell was deep-discharged, which is believed to be induced by resistance-hiking and the subsequent change in oxygen reduction reaction (ORR) kinetics. This may be caused by the over-production of an insulating species, ZnO, on the porous air cathode. To clarify whether Li⁺ or Zn²⁺ participates in the reaction with the air-cathode, a blank experiment was conducted using excess LiFePO₄ to couple with the same air-electrode in a Zn-ion free electrolyte (21 m LiTFSI electrolyte). This cell showed much lower capacity, lower CE, higher overpotential and extremely slow kinetics. Thus, it appears that the Zn reaction with O₂ at air-cathode dominates the cell chemistry with a reaction mechanism similar to that of Li/O₂ or other metal-air chemistries employing either non-aqueous or ionic liquid electrolytes.

The capacity of the Zn/O₂ cell remained stable for at least 10 cycles and then slowly decayed to 1000 mAh/g in 40 cycles, which should be caused by the degradation of O₂-cathode. The cell was also cycled under a constant-capacity mode of 1000 mAh/g (FIG. 5b), corresponding to a full-cell energy density of 300 Wh/kg (based on the cathode and anode, or 160 Wh/kg with electrolyte weight included). Limiting the capacity utilization allowed the cycle-life to be extended beyond 200 cycles, with the polarization slightly increasing with cycle number. It appears the concentrated and neutral HCZE, with its unique water-retaining capability, enables a Zn/O₂ cell with excellent cycle life, high efficiency, and a good capacity utilization that have not been observed in any conventional Zn aqueous electrolytes known thus far.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter. All references cited herein are incorporated by reference in their entirety.

What is claimed is:

1. An electrolyte for a rechargeable zinc-metal anode battery comprising:
an aqueous solution having a pH of from about 4 to about 7;
a zinc-ion based electrolyte comprising zinc ion and a first fluorine containing anion; and
a secondary salt comprising a cation and a second fluorine containing anion.

2. The electrolyte of claim 1, wherein said first or said second fluorine containing anion suppresses hydrolysis of said zinc-ion based electrolyte.

3. The electrolyte of claim 2, wherein said first or said second fluorine containing anion and said lithium salt of said fluorine containing anion inhibits formation of zinc oxide, zinc hydroxide, or both.

4. The electrolyte of claim 1, wherein said electrolyte is capable of retaining water in open atmosphere.

5. The electrolyte of claim 1, wherein said zinc-ion based electrolyte provides dendrite-free plating/stripping of Zn anode at a coulombic efficiency of at least about 95%.

6. The electrolyte of claim 1, wherein the ratio of said lithium salt of said fluorine containing anion to said zinc-ion based electrolyte is at least about 10 to 1.

7. The electrolyte of claim 1, wherein the ratio of said lithium salt of said fluorine containing anion to said zinc-ion based electrolyte is at least about 20 to 1.

8. The electrolyte of claim 1, wherein said fluorine containing anion comprises a fluoroalkylsulfonyl group of the formula: R—SO₂—, wherein R is a C₁₋₂₀ fluoroalkyl.

9. The electrolyte of claim 8, wherein R is a C₁₋₅ perfluoroalkyl.

10. The electrolyte of claim 1, wherein said fluorine containing anion is of the formula: 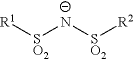
wherein each of R¹ and R² is C₁₋₂₀ alkyl or C₁₋₂₀ fluoroalkyl,
provided at least one of R¹ or R² is C₁₋₂₀ fluoroalkyl.

11. The electrolyte of claim 10, wherein at least one of R¹ or R² is a C₁₋₅ perfluoroalkyl.

12. The electrolyte of claim 1, wherein said aqueous solution comprises a non-aqueous solvent.

13. The electrolyte of claim 1, wherein said non-aqueous solvent is selected from the group consisting a linear ether, a cyclic ether, an ester, a carbonate, a formate, a phosphate, a lactone, a nitrile, an amide, a sulfone, and a sulfolane.

14. The electrolyte of claim 13, wherein said non-aqueous solvent is selected from the group consisting of propylene carbonate (PC), dimethyl carbonate (DMC), trimethyl phosphate (TMP), dimethylsulfoxide (DMSO), and dimethylformamide (DMF).

15. An aqueous rechargeable zinc-metal anode battery comprising:
(a) a zinc-metal anode;
(b) a cathode; and
(c) an aqueous electrolyte comprising:
(i) a zinc-ion based electrolyte comprising zinc ion and a fluorine containing anion; and
(ii) a secondary salt comprising a cation and a second fluorine containing anion,
wherein the coulombic efficiency of said rechargeable zinc-metal anode battery is at least about 99% after 5 recharging cycle, and wherein the pH of said aqueous electrolyte ranges from about pH 3 to about pH 7.

16. The aqueous rechargeable zinc-metal anode battery of claim 15, wherein said rechargeable zinc-metal anode battery is capable of being recharged for at least 100 cycles.

17. The aqueous rechargeable zinc-metal anode battery of claim 15, wherein the ratio of said lithium salt of said fluorine containing anion to said zinc-ion based electrolyte is at least about 10 to 1.

18. The rechargeable zinc-metal anode battery of claim 15, wherein said cathode comprises an oxide, a sulfide, a selenide, or a combination thereof.

19. The rechargeable zinc-metal anode battery of claim 15, wherein said fluorine containing anion is of the formula: 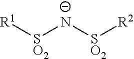
wherein each of R¹ and R² is C₁₋₅ alkyl or C₁₋₅ fluoroalkyl,
provided at least one of R¹ or R² is C₁₋₅ fluoroalkyl.

20. The rechargeable zinc-metal anode battery of claim 15, wherein said fluorine containing anion comprises trifluorosulfonylimide, bis(fluorosulfonyl)imide, or a moiety of the formula: R—SO₂—, wherein R is a C₁₋₂₀ fluoroalkyl.
